(19) United States
(12) Patent Application Publication
(10) Pub. No.: US 2008/0131697 A1
(43) Pub. Date: Jun. 5, 2008

(54) Multi-dimensional effect decorative covering and method for constructing same

(76) Inventor: Michael Solano, Dover, NJ (US)

Correspondence Address: LEN TAYLOR, PATENT ATTORNEY, 261 DAVENPORT STREET, SOMERVILLE, NJ, 08876, US

(21) Appl. No.: 11/880,227

(22) Filed: Jul. 19, 2007

Related U.S. Application Data
(60) Provisional application No. 60/831,785, filed on Jul. 19, 2006.

(51) Int. Cl. B32B 27/36; B32B 27/08; B05D 1/36

(52) U.S. Cl. 428/364; 428/483; 428/402; 156/313; 428/523

(57) ABSTRACT

A method for constructing a multi-dimensional effect decorative covering comprising combining a translucent medium with a colorant such as ink, applying the translucent medium having the colorant to at least one surface of at least one of a plurality of transparent films, and layering the plurality of transparent films upon one another whereby the applied translucent medium having the colorant is between at least two of the plurality of transparent films.

This application claims the benefit of U.S. Provisional Application 60/831,785 filed Jul. 19, 2006.

### BACKGROUND OF THE INVENTION

1. Field of the Invention

The present invention generally relates to a multi-dimensional effect covering that can be applied to walls, flooring, counter tops, or other surfaces that a decorative covering would be used on. Particularly the multi-dimensional effect covering comprises a plurality of transparent film layers for example vinyl, poly-vinyl, milled, extruded, or calendared films wherein varying amounts of colorants are combined with translucent mediums such as but not limited to acrylic, adhesive, latex, urethane, or glue and then applied to at least one of an upper surface and a lower surface of at least one of the plurality of transparent film layers. The transparent film layers can be totally transparent, partially transparent, or a combination of both. The varying amounts of colorants and translucent mediums can be combined to have varying degrees of translucency. Another embodiment according to the present invention comprises at least one layer of varying amounts of at least one of colorants, pigments, and coloring agents for example dyes or raw pigments, and translucent mediums between at least two of the plurality of transparent film layers. Another embodiment according to the present invention comprises incorporating additional layers of materials either without a translucent medium or in combination with a translucent medium. The additional layers of materials can be but are not limited to printed non-wovens, non-printed non-wovens, natural fibers, synthetic fibers, paper, flakes of material for example metallic flakes, stone flakes, and crystalline flakes, granular material for example stone such as mica. The additional layers of materials can be incorporated into the design of the covering to enhance depth and the overall multi-dimensional appearance of the covering. Translucent colored adhesive or bonding material may be used but does not have to be used, to adhere the plurality of transparent film layers together. More particularly a multi-dimensional effect of the covering can be achieved by being able to view varying amounts of translucent mediums combined with colorants, adhesives, and other materials used in the construction of the covering through each of the adjoining transparent film layers whereby a dimension of depth is achieved. Moreover the translucent mediums combined with colorants allow light to penetrate the plurality of transparent film layers at varying rates further enhancing depth perception. Additionally, a base sheet having light reflective or light distorting properties may be incorporated into the covering. The base sheet can include but is not limited to metallic materials, Mylar® a registered trademark of E. I. DU PONT DE NEMOURS AND COMPANY CORPORATION, color shifting materials, holographic sheets, and lentacular sheets.

2. Description of the Prior Art

Various coverings for surfaces in the human habitat have long been used both for protective and decorative purposes. Walls and ceilings have been traditionally protected and decorated by plaster, paint, tapestries, paneling, wallpaper, metal sheeting and tile. Floors have typically been covered by ceramic tiles, vinyl and plastic tiles and sheets, linoleum, carpet, parquet and wood slats, again. Work stations, such as countertops, and even articles of furniture, such as tables, have been covered by ceramic or stone materials, metal sheets, thermoformed plastic sheets, paneling, veneer and similar materials.

As a result of the desirability of various finishes for such surfaces, there is a constant demand for new decorative coverings. Interior designers and others involved in selecting surface coverings typically seek out “new looks” to incorporate in the overall aesthetic presentation of living and work spaces. The present invention is directed to the production of unique decorative coverings which, according to the methodologies of the present invention may be constructed as “one of a kind” coverings or which may be reproducible in a variety of surface covering media.

### SUMMARY OF THE INVENTION

An object of the present invention is to provide an efficient solution to the problem of creating multi-dimensional decorative coverings that can be applied to walls, floorings, counter tops, automotive surfaces, or other surfaces that may be decorated such as a support beam, shower surround, column, packaging, advertising materials, and printing material.

Another object of the present invention is an inexpensive decorative covering adaptable to a variety of multi-dimensional effects for example a decorative covering that simulates a natural appearance of marble, granite, or wood.

Another object of the invention is to construct an efficient decorative covering that enhances an appearance of depth within the decorative covering by incorporating translucent colorants and adhesives as part of the overall decorative design.

Another object of the invention is to construct an efficient decorative covering that enhances an appearance of depth within the decorative covering by incorporating colorants, pigments, and coloring agents for example dyes, raw pigments, ink, metallic pigments, iridescent pigments, opalescent pigments, pearlescent pigments with a translucent mediums such as acrylic as part of the overall decorative design.

Another object of the invention is to construct an inexpensive efficient covering that enhances an appearance of depth within the covering by incorporating additional layers of material such as printed non-wovens, non-printed non-wovens, fabric, paper, wood, flakes of material for example metallic flakes, stone flakes, and wood flakes, and granular material for example stone in between the transparent film layers.

A further object of the invention is a method of layering a plurality of transparent films whereby at least one of said plurality of transparent films has a colorant or a plurality of colorants combined with translucent mediums that are applied on at least one of an upper surface and a lower surface of said at least one of said plurality of transparent films to provide an appearance of depth.

A further object of the invention is a method of layering a plurality of transparent films whereby at least one of said plurality of transparent films has translucent adhesive or bonding agent applied on at least one of an upper surface and a lower surface of said at least one of said plurality of transparent films to provide an appearance of depth whereby the translucent adhesive can be applied in conjunction with the translucent colorant.

Thus a need exists for a multi-dimensional effect decorative covering that adds an appearance of depth to any surface that it is applied to. A further need exists for an improved multi-dimensional effect decorative covering that can be manufactured using existing machinery and yet is capable of providing a multi-dimensional effect.

### BRIEF DESCRIPTION OF THE DRAWINGS

Preferred embodiments of the present invention will be described below in more detail, with reference to the accompanying drawings:

FIG. 1 is a schematic representation of a view of a plurality of transparent film layers according to an embodiment of the present invention;

FIG. 2 is a representation of a front view of a multi-dimensional effect covering according to an embodiment of the present invention; and

FIG. 3 is a flow chart of a method for making a multi-dimensional effect covering according to an embodiment of the present invention.

### DETAILED DESCRIPTION OF THE INVENTION

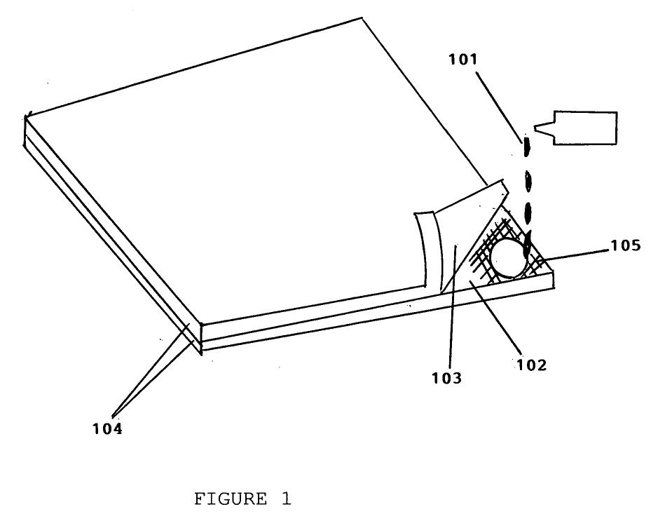

Referring to FIG. 1 an embodiment of a multi-dimensional effect decorative covering according to the present invention is illustrated. A translucent medium 101 combined with a colorant is applied to at least one of an upper surface 102 and a lower surface 103 of at least one of a plurality of transparent film layers 104 for example vinyl, poly-vinyl, polyester, milled, extruded, or calendared films, however the translucent medium 101 does not have to be combined with a colorant. In another embodiment according to the present invention each of the plurality of transparent film layers can be totally transparent, partially transparent, or a combination of both.

Another embodiment according to the present invention comprises incorporating additional layers of materials 105 either without a translucent medium being applied or in combination with a translucent medium. The additional layers of materials 105 can also include film layers that are not transparent. Translucent adhesive may further be applied to at least one of an upper surface and a lower surface of the at least one of a plurality of transparent films for joining the transparent film layers 104 that are layered together and to further enhance the appearance of depth. A preferred embodiment according to the present invention comprises mixing a colorant with a translucent medium such as acrylic, latex, or urethane. The colorant can be but does not have to be ink. Additionally chemical interactions between materials for example glue, water, and alcohol, can be used to create designs, voids, gaps, and crevices in the applied translucent medium to further enhance a perception of depth. Another embodiment according to the present invention comprises at least one layer of varying amounts of at least one of colorants and translucent mediums between at least two of the plurality of transparent film layers.

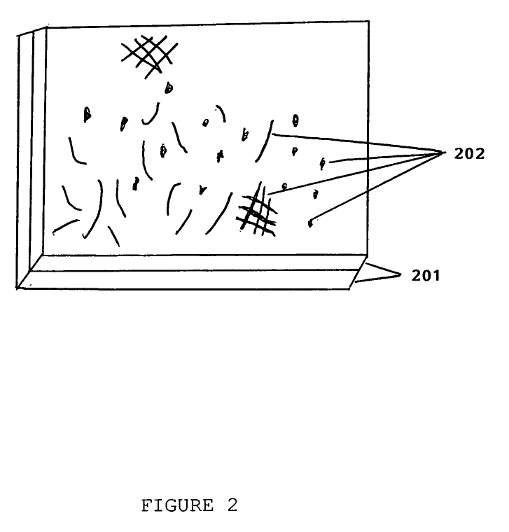

Referring to FIG. 2 a multi-dimensional effect decorative covering comprising a plurality of transparent film layers 201 each transparent film layer having an upper surface and a lower surface whereby a colorant that is mixed with a translucent medium such as acrylic or glue is applied to at least one of the upper surface and the lower surface of at least one of the plurality of transparent film layers. When the transparent films are layered upon one another light can penetrate through each layer and either reflect, partially reflect, or penetrate through the various colorants and translucent mediums that have been applied on adjoining surfaces of the various transparent film layers. The interaction of materials applied between the plurality of transparent film layers creates a multi-dimensional effect by enhancing depth. Translucent colored adhesives or bonding materials can also be applied to at least one of the upper surface and the lower surface to allow the plurality of transparent film layers to adhere together. Adherence may also be accomplished using heat, pressure, or any other adhesion method known in the art. The translucent medium combined with colorant can be applied on at least one of the upper surface and the lower surface in a random pattern creating designs, irregular pockets, gaps, or voids in which no colorant is applied. Another embodiment according to the present invention comprises using chemical reactions of different materials for example glue, water, and alcohol, to create random and non-random patterns, gaps, and voids in the translucent medium further enhancing depth perception. The translucent colorant can also be applied in a non-random pattern should a particular type of design be desired such as wood, marble, or patterns. The transparent film layers can be further embossed, printed with various designs and patterns, or embossed and printed with various designs and patterns on either or both sides of at least one of the transparent film layers to create gaps or voids between the transparent film layers. Additionally when a particular simulated look is desired for example marble, flakes of material 202 such as crystalline flakes, granular materials such as stone chips and fragments for example mica particles, can be positioned between the plurality of transparent film layers. In a preferred embodiment according to the present invention the granular material is positioned within gaps or pockets that are created by randomly applying translucent colorants and adhesives. Materials 202 such as wood particles, fibers, printed non-wovens, non-printed non-wovens, natural fibers, or fabric threads can also be layered in between the transparent film layers to create additional depth. Opaque colorants and opaque adhesives may also be used but do not have to be used, in conjunction with the translucent mediums and translucent adhesives to create a design. A multi-dimensional effect is created when layering the transparent films having translucent medium combined with varying amounts of colorants, translucent adhesives, and any desired additional material in between the transparent film layers. Since each transparent film layer allows a certain percentage of light to pass through it a desired depth effect is enhanced due to light reflecting, partially reflecting, or penetrating the various combined layers of transparent film, translucent medium combined with colorant, translucent adhesives, and any materials that have been applied throughout the decorative layered covering. When decorating a surface the multi-dimensional decorative layered covering can be further joined to a variety of substances such as wall paper backing, counter top under layers, wood, plastic, metal, glass, publishing materials, advertising materials, packaging materials and any other surface substance that can be decorated. Another embodiment according to the present invention can use at least one of light reflective and light distorting backings as a bottom surface of the multi-dimensional covering. The backings can be but are not limited to materials such as metallic materials, Mylar® a registered trademark of E. I. DU PONT DE NEMOURS AND COMPANY CORPORATION, color shifting materials, holographic sheets, and lentacular sheets. An advantage of the present invention is that a multi-dimensional decorative covering constructed to simulate the appearance of a natural material for example marble, shells, or pearls, is much less expensive than actual sheets of marble. An additional advantage is that the multi-dimensional decorative covering that simulates a marble appearance can be constructed to be flexible whereas actual marble stone is brittle and rigid. A desired multi-dimensional effect of the decorative covering can be achieved by varying the amounts of colorants that are combined with translucent mediums and by varying placement and amounts of the translucent mediums, adhesives when applied, opaque colorants when applied, and other materials 202 such as fabric, wood splinters, and granular particles when applied, between the plurality of transparent film layers. The desired multi-dimensional effect can be further enhanced by embossing either randomly or non-randomly at least one of the plurality of transparent film layers whereby gaps, pockets, or voids are created either in a random, non-random, or combined random and non-random position. Another embodiment according to the present invention comprises using chemical reaction between various substances such as glue, water, and alcohol to create designs, pockets, gaps, and voids either in a random, non-random, or combined random and non-random position in the translucent medium and in between the translucent film layers.

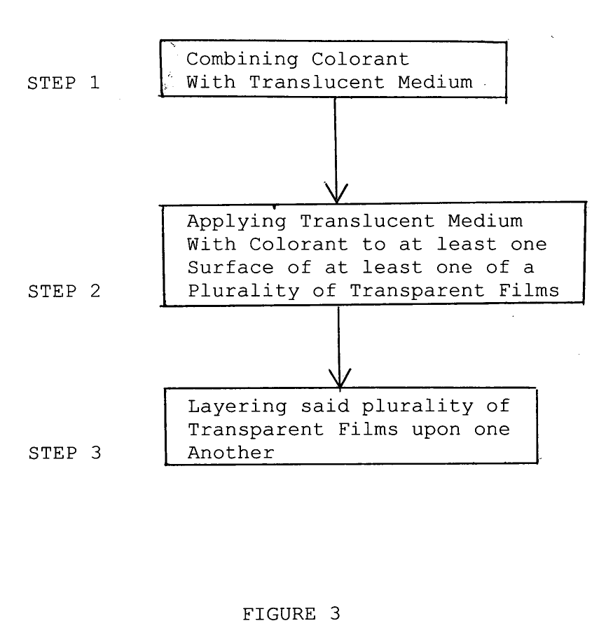

Referring to FIG. 3 which illustrates a method for constructing a multi-dimensional effect decorative covering according to an embodiment of the present invention, a translucent medium is combined with a colorant such as ink (Step 301). The translucent medium having the colorant is applied to at least one of an upper surface and a lower surface of at least one of a plurality of transparent film layers (Step 302). The plurality of transparent films are layered upon one another whereby the applied translucent medium having the colorant is between at least two of the plurality of transparent film layers (Step 303). In another embodiment according to the present invention, materials such as wood particles, fibers, printed non-wovens, non-printed non-wovens, natural fibers, fabric threads, granular materials can be positioned in between at least two of the plurality of transparent film layers.

Having described embodiments for a multi-dimensional effect decorative covering and method for constructing same, it is noted that modifications and variations can be made by persons skilled in the art in light of the above teachings. It is therefore to be understood that changes may be made in the particular embodiments of the invention disclosed which are within the scope and spirit of the invention as defined by the appended claims.

What is claimed is:

1) A multi-dimensional effect decorative covering comprising:
A plurality of transparent film layers each of the transparent film layers having an upper surface and a lower surface, and
At least one translucent medium applied onto at least one of the upper surface and the lower surface of at least one of the plurality of transparent film layers.

2) The multi-dimensional effect decorative covering of claim 1, wherein the plurality of transparent film layers comprises at least one of vinyl, poly-vinyl, polyester, milled, extruded, and calendared films.

3) The multi-dimensional effect decorative covering of claim 1, wherein the at least one translucent medium further comprises at least one colorant.

4) The multi-dimensional effect decorative covering of claim 3 wherein the colorant includes at least one of inks, pigments, dyes, raw pigments, metallic pigments, iridescent pigments, opalescent pigments, and pearlescent pigments.

5) The multi-dimensional effect decorative covering of claim 1, wherein the at least one translucent medium includes at least one of acrylic, adhesive, latex, urethane, and glue.

6) The multi-dimensional effect decorative covering of claim 1, further comprising at least one of crystalline flakes, granular materials, stone chips, stone fragments, wood particles, fibers, printed non-wovens, non-printed non-wovens, natural fibers, and fabric threads, applied onto at least one of the upper surface and the lower surface of at least one of the plurality of transparent film layers.

7) The multi-dimensional effect decorative covering of claim 1, wherein at least one of the plurality of transparent film layers includes at least one of a randomly embossed and a non-randomly embossed transparent film layer.

8) A method for constructing a multi-dimensional effect decorative covering comprising:
Combining at least one translucent medium with at least one colorant,
Applying the at least one translucent medium with at least one colorant to at least one of an upper surface and a lower surface of at least one of a plurality of transparent film layers,
Layering each of the plurality of transparent film layers upon one another such that the translucent medium with at least one colorant is in between at least two of the plurality of transparent film layers.

9) The method of claim 8, wherein the step of combining the at least one translucent medium includes the step of combining the at least one translucent medium, wherein the at least one translucent medium includes at least one of acrylic, adhesive, latex, urethane, and glue.

10) The method of claim 8, wherein the step of combining the at least one translucent medium includes the step of combining the at least one translucent medium, wherein the at least one colorant includes at least one of inks, pigments, dyes, raw pigments, metallic pigments, iridescent pigments, opalescent pigments, and pearlescent pigments.

11) The method of claim 8, further comprising the step of layering at least one of crystalline flakes, granular materials, stone chips, stone fragments, wood particles, fibers, printed non-wovens, non-printed non-wovens, natural fibers, and fabric threads between at least two of the plurality of transparent film layers.

12) The method of claim 8, further comprising the step of using chemical reactions of different materials to create at least one of random patterns, non-random patterns, gaps, and voids in the translucent medium.
